(19) United States
(12) Patent Application Publication
(10) Pub. No.: US 2013/0325779 A1
(43) Pub. Date: Dec. 5, 2013

(54) RELATIVE EXPERTISE SCORES AND RECOMMENDATIONS

(71) Applicants: Ben Shahshahani, Menlo Park, CA (US); Su-Lin Wu, San Carlos, CA (US)

(72) Inventors: Ben Shahshahani, Menlo Park, CA (US); Su-Lin Wu, San Carlos, CA (US)

(73) Assignee: Yahoo! Inc., Sunnyvale, CA (US)

(21) Appl. No.: 13/483,857

(22) Filed: May 30, 2012

(51) Int. Cl. G06N 5/02

(52) U.S. Cl. 706/46

(57) ABSTRACT

Content recommendations customized to a user's knowledge are provided. The user's knowledge is assessed from the user's activity history and the expertise of the user regarding each of the various topics relative to a cohort group is determined. Based on the user's score, the user can be classified into various competency levels ranging from a novice to an expert in each topic. Content items for improving the user's scores in the various topics can be forwarded based on the user's classification and activity history. If the user is recognized as an expert in a particular topic, questions from other users regarding the particular topic can be directed to the user for the responses.

The present disclosure relates to measuring expertise scores of users relative to other users and providing content recommendations based on such scores.

### BACKGROUND

The explosive growth of information available online has lead to information overload becoming a significant problem. In addition, the increasing reach of the Internet via stationary and mobile devices, and technologies that track user habits have made available more and more information about the users to content providers. This has led to various content recommendation applications and algorithms that aim at mitigating the information overload problem by providing user specific content recommendations.

### SUMMARY

This disclosure facilitates recommending content that is personalized to a user's expertise level in the user's topics of interest. A method executed by a processor for determining the expertise or knowledge of a user with respect to particular content topics relative to a selected cohort group comprising other users and recommending content based on such determination is disclosed in accordance with one embodiment. The method begins with accessing and analyzing activity history of a first user to obtain a plurality of topics which can be of interest to the user and/or in which the first user possesses expertise. An initial score indicative of the knowledge of the first user about at least one of the topics is determined by the processor from the activity history. In an embodiment an initial score for the at least one topic can be determined based on the content items associated with the at least one topic for prior X days from the activity history, X being a natural number. Aboutness intensities for each of the content items for the at least one topic are received and are weighed with respective time decay factors and sophistication factors to bias the results towards recent content items and to account for the appropriate level of sophistication or difficulty of the content items consumed by the first user for the at least one topic. The initial score for the user is determined based on the weighed aboutness intensities for the content items. Additionally, initial scores for each of the other users, within a selected cohort group, for the at least one topic are also similarly determined from respective activity histories of the other users. The initial score of the first user is compared with the initial scores of the other users from the cohort group to generate the relative score indicative of the knowledge of the first user about the at least one topic relative to the cohort group. The content for increasing the initial score of the first user is identified and transmitted by the processor, to the first user.

In an embodiment, content items associated with the at least one topic are obtained and an aboutness intensity indicative of a strength of association between each content item and the at least one topic, is determined for each of the obtained content items. The content items are then ranked based on respective aboutness intensities and those of the highly ranked content items which are most closely associated with the at least one topic and which were previously not accessed by the first user are identified as the additional content to be transmitted to the user for increasing the scores of the first user.

In an embodiment, the first user is classified as one of a novice, an intermediate user or an expert based on the initial score. If the first user is classified as an expert on the at least one topic, questions associated with the at least one topic are forwarded to the first user for responses based on, for example, permissions set by the first user.

In an embodiment, the expertise or knowledge of the first user can be determined for a plurality of topics obtained from the activity history of the first user. In an embodiment, other users having attributes similar to the first user are identified by the processor and the cohort group comprising the other users with the similar attributes is generated by the processor as a default cohort group for the first user. In an embodiment, a plurality of possible cohort groups can be suggested by the processor for selection by the first user such that a respective cohort group from the plurality of possible cohort groups is selected for each of the plurality of topics by the first user. In this embodiment, respective initial scores for the first user are determined for each of the plurality of topics and respective relative scores indicative of knowledge of the first user about each of the plurality of topics relative to a respective cohort group are also generated. This facilitates identifying, by the processor, strong and weak topics for the first user from the plurality of topics based on the relative scores.

In another embodiment, a computing device, comprising a processor and a storage medium for tangibly storing thereon programming logic associated with the an expertise engine that recommends topic-wise content based on the expertise of the users, for execution by the processor, is disclosed. The programming logic comprises analyzing logic, executed by the processor, for analyzing activity history of a first user, determining logic, executed by the processor, for determining an initial score indicative of knowledge of the first user about at least one topic from the activity history and generating logic, executed by the processor, for generating a relative score indicative of the knowledge of the first user about the at least one topic relative to at least one cohort group comprising other users. Content identifying logic, executed by the processor, identifies additional content for increasing the scores of the first user, which content is then transmitted by the processor to the first user by employing the transmitting logic executed therein. In one embodiment, the determining logic further comprises logic for determining initial scores for each of the other users from respective activity histories. In an embodiment, the generating logic further comprises, logic for comparing, the initial score of the first user with the initial scores of the other users to generate the relative score. In an embodiment, the content identifying logic further comprises logic for obtaining content items associated with the at least one topic, logic for determining an aboutness intensity for each of the obtained content items, the aboutness intensity indicates a strength of association between each content item and the at least one topic, logic for ranking the content items based on respective aboutness intensities and logic for selecting highly ranked content items most closely associated with the at least one topic and previously not accessed by the first user as the additional content to be transmitted to the user. In one embodiment, such additional content can be obtained from activity histories of the other users included in the cohort group. In one embodiment, the processor further executes user identifying logic for identifying the other users having attributes similar to the user and group generating logic, for generating the cohort group comprising the other users with the similar attributes. In an embodiment, the processor also executes, classifying logic, for classifying the first user as one of a novice, an intermediate user or an expert based on the initial score.

A computer readable storage medium, having stored thereon, instructions for execution by a processor is disclosed in accordance with another embodiment. The instructions cause the processor to analyze activity history of a first user and determine an initial score indicative of knowledge of the first user about at least one topic from the activity history. In an embodiment, the processor identifies other users having attributes similar to the user and generates at least one cohort group comprising the other users with the similar attributes. Additionally, the processor generates a relative score indicative of the knowledge of the first user about the at least one topic relative to the at least one cohort group, identifies additional content for increasing the initial score of the first user and transmits the additional content to the first user. In an embodiment, the processor determines initial scores for each of the other users from respective activity histories and compares the initial score of the first user with the initial scores of the other users to generate the relative score.

In an embodiment, the medium further comprises instructions to obtain content items associated with the at least one topic, determine an aboutness intensity for each of the obtained content items, wherein the aboutness intensity is indicative of a strength of association between each content item and the at least one topic. Further instructions comprised within the processor rank the content items based on respective aboutness intensities and select highly ranked content items most closely associated with the at least one topic and previously not accessed by the first user as the additional content to be transmitted to the user.

These and other embodiments and embodiments will be apparent to those of ordinary skill in the art by reference to the following detailed description and the accompanying drawings.

### BRIEF DESCRIPTION OF THE DRAWINGS

In the drawing figures, which are not to scale, and where like reference numerals indicate like elements throughout the several views:

FIG. 1 is a block diagram depicting certain modules within a system providing user-specific recommendations in accordance with an embodiment of the present disclosure;

FIG. 2 is a block diagram depicting certain modules within the expertise engine in accordance with an embodiment of the present disclosure;

FIG. 3 shows a flowchart illustrating an embodiment of a method of recommending content to the user in accordance with an embodiment of the present disclosure;

FIG. 4 shows a flow chart illustrating an embodiment of a method of determining a user's score for a topic in accordance with one embodiment;

FIG. 5 shows a flow chart illustrating an embodiment of a method of selecting content for a user in accordance with an embodiment;

FIG. 6 shows a flowchart illustrating an embodiment of a method of selecting topic-specific content for a user in accordance with one embodiment;

FIG. 7 is an illustration wherein the scores and associated recommended content are provided to the user in accordance with an embodiment of the present disclosure;

FIG. 8 is a schematic diagram showing the internal architecture of a computing device including one or more processing units (also referred to herein as CPUs), which interface with at least one computer bus in accordance with one embodiment of the present disclosure;

FIG. 9 is a schematic diagram illustrating a client device implementation of a computing device in accordance with embodiments of the present disclosure.

### DESCRIPTION OF EMBODIMENTS

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

In the accompanying drawings, some features may be exaggerated to show details of particular components (and any size, material and similar details shown in the figures are intended to be illustrative and not restrictive). Therefore, specific structural and functional details disclosed herein are not to be interpreted as limiting, but merely as a representative basis for teaching one skilled in the art to variously employ the disclosed embodiments.

The present invention is described below with reference to block diagrams and operational illustrations of methods and devices to select and present media related to a specific topic. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer, special purpose computer, ASIC, or other programmable data processing apparatus, such that the instructions, which execute via the processor of the computer or other programmable data processing apparatus, implements the functions/acts specified in the block diagrams or operational block or blocks.

In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved. Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and applications software which support the services provided by the server.

For the purposes of this disclosure a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), or other forms of computer or machine readable media, for example. A network may include the Internet, one or more local area networks (LANs), one or more wide area networks (WANs), wire-line type connections, wireless type connections, cellular or any combination thereof. Likewise, sub-networks, which may employ differing architectures or may be compliant or compatible with differing protocols, may interoperate within a larger network. Various types of devices may, for example, be made available to provide an interoperable capability for differing architectures or protocols. As one illustrative example, a router may provide a link between otherwise separate and independent LANs.

A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. Furthermore, a computing device or other related electronic devices may be remotely coupled to a network, such as via a telephone line or link, for example.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like. Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

Throughout the specification and claims, terms may have nuanced meanings suggested or implied in context beyond an explicitly stated meaning Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part. In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Personalizing content recommendations is one method that can be employed by content providers to help users cope with the overload of information they face each day which in turn leads to user attention being split between the various information sources. Many content providers request users for their input and such input in combination with various explicitly and implicitly collected user attributes is employed to personalize content for the users. One of the user attributes that can aid in personalizing content is not only an indication of a user's interest in a particular topic, but also the level of expertise that a user possesses with respect to the topic. When an indication of a user's interest in a particular topic is received, various content sources provide the user with content associated with that topic. While consuming the content from these various sources over a period of time, the user attains greater knowledge and a certain level of competence in that particular topic. In addition, other user attributes such as, but not limited to, the user's educational background, profession, place of origin/residence, can lead to the user having a certain level of knowledge in various topics/entities associated with such attributes. Accordingly, personalized content can be provided to the users taking into consideration the level of the users' knowledge with respect to various topics. Such personalization can not only lead to providing content of greater interest to the users, but it can also lead to other interesting user experiences such as but not limited to, the users being able to estimate their respective level of expertise regarding a particular topic relative to other users and providing social networking opportunities via online quizzes, games with other users as will be described in embodiments discussed further herein.

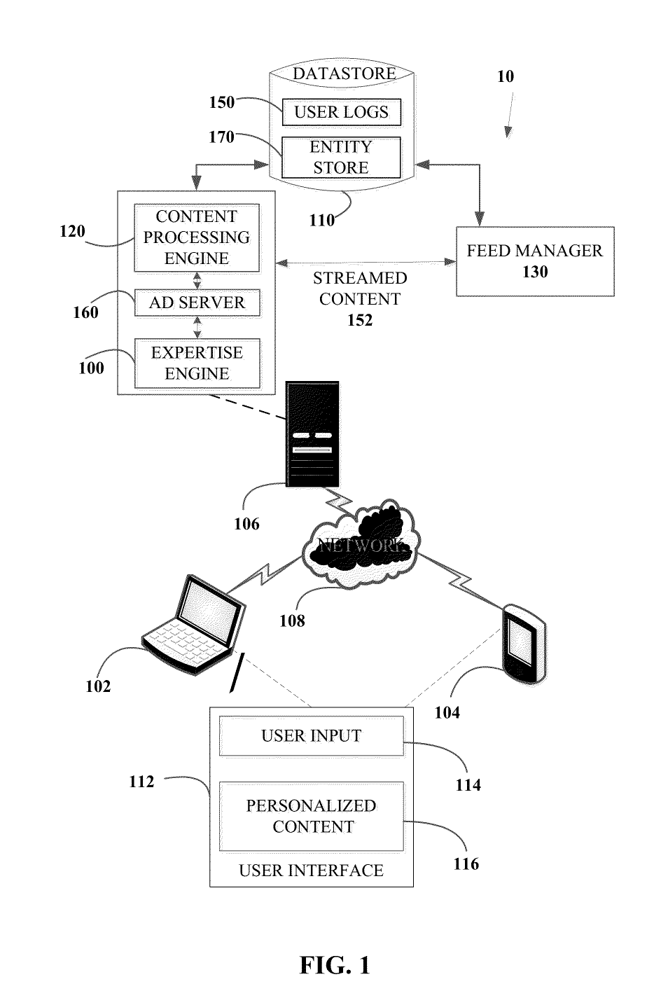

Turning now to the figures, FIG. 1 is a block diagram depicting certain modules within a system 10 providing user-specific recommendations. A user computing device/client device 102 or 104 communicates over a network 108 such as the Internet with a server computer 106 executing a expertise engine 100 and a content processing engine 120 coupled to a datastore 110. Although the server computer 106 is shown as comprising both the expertise engine 100 and the content processing engine 120 it can be appreciated that this is only by the way of illustration and not limitation and that these engines can be installed on disparate computers which may be located in proximity or remotely from each other connected via the network 108. The client devices 102/104 are employed by users to display a user interface 112 associated with the expertise engine 100. In different embodiments, the user interface 112 of the expertise engine 100 can be displayed via a web browser or a mobile application, referred to herein as “app”. In one embodiment, the user interface 112 includes a user input area 114 wherein a user can enter user credentials such as a user name and/or password to access resources associated with the server computer 106 such as but not limited to the expertise engine 100. In an embodiment, if the user is a registered user of the expertise engine 100, upon verifying the user credentials, the expertise engine 100 in association with the content processing engine 120 produces personalized content 116 that can comprise but is not limited to, topic-wise scores indicating the user's expertise levels with regard to various topics relative to a selected cohort group, the user's strong and weak topics, content suggestions for the various topics that the user can employ in order to improve the scores, information related to the cohort group or other updates associated with the expertise engine 100. The content suggestions for various topics can be selected from content stored in the datastore 110 or can be content 152 which is streamed by the feed manager 130. Additionally, the personalized content 116 can also include advertisements produced by the ad server 160 which, in an embodiment, can be located on the same server computer 106 as the expertise engine 100 or it may be located on a disparate server (not shown) communicatively coupled to the server computer 106 via the network 108.

If the user is not already registered with the server computer 106 or the expertise engine 100, a process to register the user can be initiated. In an embodiment, user information such as user selections for user name, password, security options and other information generally collected during the initial user registration can be requested in addition to other user attributes. The user attributes collected during the registration process can comprise but are not limited to, user demographic and location information, educational qualifications, profession and social networking information. For example, the user can provide information associated with user accounts on social networking platforms such as but not limited to, TWITTER, FACEBOOK, LINKEDIN, QUORA. In an embodiment, the user can already be a registered user of the server computer 106 and is a new user of the expertise engine 100. In this embodiment, prior user activity records or user logs 150 stored, for example, on the datastore 110 can be accessed and mined for obtaining information regarding the user attributes. Therefore, various sources such as but not limited to, URL (Universal Resource Locator) of pages that were provided to the user by the server computer 106, Tweets that the user has sent and URLs shared by the user via tweet or re-tweets, pages that the user has ‘liked’ via FACBOOK or similar buttons, questions the user has answered on QUORA/YAHOO! answers, and/or answers to the questions the user has posted on QUORA/YAHOO! answers, places, establishments the user has checked into, television programs the user has watched or tagged via INTONOW, DIRECTED TV, financial portfolio information and teams in Fantasy Sports can be mined to obtain information regarding the user. Additionally, for each user, the online user behavior is mined from logs, public information on the web, as well as the user's declared activities on social networks, such as TWITTER, FACEBOOK, LINKEDIN, QUORA/YAHOO! answers, YELP, FLICKR, 4SQUARE, INTONOW.

In an embodiment, based on the user activity, user attribute information comprising various topics which are of interest to the user are implicitly identified by the expertise engine 100. In addition, the expertise engine 100 can also ask the user to explicitly enter topics of interest and/or expertise. Further, the expertise engine 100 can also request the user to select a cohort group comprising other users for each topic. In an embodiment, the cohort group can comprise other users with similar attributes as the user who are automatically selected by the expertise engine 100. In an embodiment, the cohort group generated by the expertise engine 100 can comprise the user's social contacts, such as but not limited to, the members who may be on the user's instant messenger list, or members of the user's email contacts or other social networking platforms or combinations thereof. In an embodiment, the users may define their cohort groups by providing information regarding each of the other users to be included into the cohort groups.

In one embodiment, an initial score is generated for the user for a topic based on the user activity from the user logs 150. When the user provides a cohort group or selects a cohort group from a plurality of possible cohort groups provided by the expertise engine 100, relative or comparative score of the user for each topic relative to the other users within the cohort group is generated based on a comparison of the initial score of the user with the initial scores of the other users as obtained from their respective activity histories from the user logs. Based on the various scores generated for the user, the expertise engine 100 can recommend content to the user in each topic, which content the user can read/consume in order to improve the score for respective topics. In an embodiment, based on a user's initial score for a particular topic, the expertise engine 100 can recognize that the user is an expert on the topic. Accordingly, the expertise engine 100 can request the user's permission to direct questions of other users in the user's topic of expertise. In one embodiment, the user can choose to answer the questions anonymously. In an embodiment, the user may choose to have his/her identifying indicia to be provided along with the user's answers.

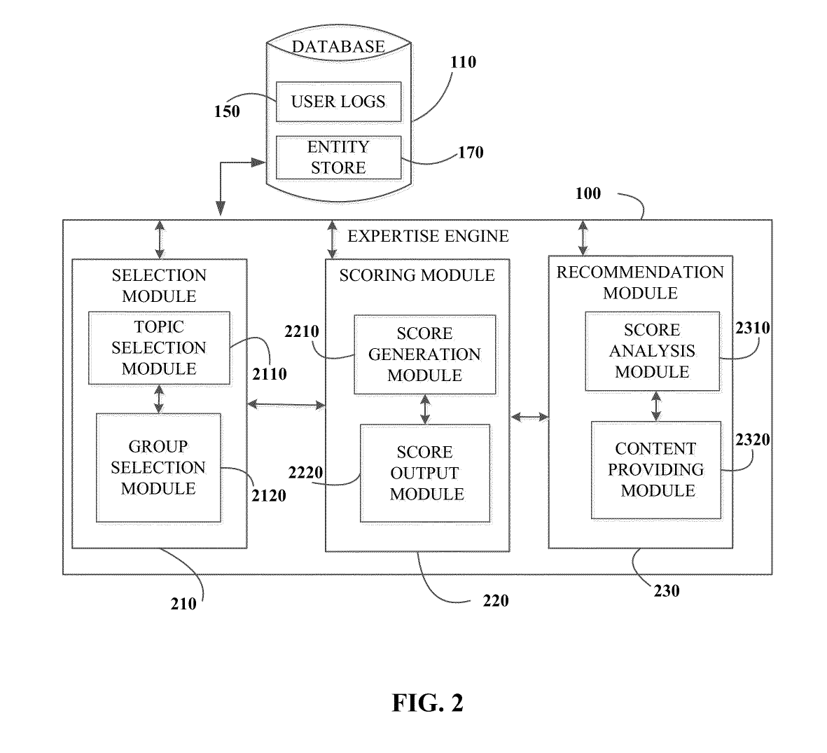

FIG. 2 is a block diagram depicting certain modules within the expertise engine 100. The expertise engine 100 can comprise, in one embodiment, a selection module 210, a scoring module 220 and a recommendation module 230. As described supra, when the user initially registers with the expertise engine 100, various attributes of the user are collected via explicit requests to the user or implicitly, for example, via various accounts that the user links up to the expertise engine 100, and/or the user's prior activity based on its availability. The information thus collected is analyzed by the selection module 210 to identify topics of interest to the user and/or topics of expertise of the user and to identify a cohort group for the user. In an embodiment, topics of interest to the user can be the same as topics of greater user expertise. In an embodiment, the topics of interest to the user may not be the same as topics associated with greater user expertise. A topic selection module 2110 can access user logs 150 comprising the user's prior activity history stored, for example, on the datastore 110 or with other data sources or platforms that the user has linked to the expertise engine 100. The topic selection module 2110 can mine such data sources to determine topics of interest to the user.

For example, contents of the user logs 150 that can include actual URLs (landing pages) are processed by a content processing system 120 to build a database of entities/an entity store 170. For each page, the key entities are extracted, for example, by natural language processing techniques, resolved to a predefined database, such as the entity store 170 and ranked on importance. Additionally each page is classified into a taxonomy and the top N (N being a natural number) categories and associated scores can be saved, for example, in the entity store 170 of the datastore 110. Similarly, meta information such as television shows, local businesses are gathered from the corresponding social networking activities to identify the different entities.

Based on criteria such as, but not limited to, the frequency of the occurrence of various entities within the logs of a particular user, the entities can be ranked to identify various topics of interest to the user and also to generally identify the user's expertise in various topics. In an embodiment, a topic can be a precisely defined entity, such as a person, a location or a particular occurrence of an event. In an embodiment, the topic can cover a broader concept such as but not limited to, a field of study or a country. Greater frequency of occurrence of a particular topic/entity within a respective activity log of the user can indicate not only greater interest of the user but also greater expertise or greater amount of knowledge of the user regarding that particular topic. Hence, a topic or a frequently occurring entity can be ranked higher in the list of selections made by the topic selection module 2110 for the user. In another embodiment, the topic selection module 2110 can allow user customization of the list of topics it generates whereby, the user can add topics to the list of topics or can remove topics which have been added to the list of topics generated by the topic selection module 2110. Thus, the expertise engine 100 facilitates the users to add new topics in which they may have newly developed interest and in which they wish to gain knowledge to the list of topics. In one embodiment, the topic selection module 2110 can generate a plurality of topic listings, each listing respectively comprising topics associated the user's areas of interests and the user's areas of expertise wherein each of the plurality of listings can be further customized by the user and/or via further analysis by a scoring process as described herein.

The selection module 210 also additionally comprises a group selection module 2120. The group selection module 2120 is operative to provide one or more cohort groups comprising other users against whom a user may wish to compare his/her knowledge regarding a given topic. In one embodiment, the group selection module 2120 automatically provides a default group to the user based on the user's attributes. The default group provided to the user can comprise other users who have similar attributes as the user. For example, other users having similar age, location, educational, demographic and/or professional attributes as the user can make up the user's default cohort group. Based on the other user's permissions, for example, they may remain anonymous or their identity may be provided to the user. In an embodiment, the user can select the members of the cohort group. For example, the user's contacts such as the user's instant messenger contacts or email contacts or contacts on social networking platforms that the user has linked to the expertise engine 100 can form the user's cohort group(s). In an embodiment, a plurality of cohort groups comprising groups with anonymous users as selected by the expertise engine 100 and groups with user's social contacts discussed herein can make up a user's collection of cohort groups maintained by the group selection module 2120 so that the user can select different cohort groups for different topics in order to estimate the relative knowledge. In an embodiment, the expertise engine 100 can monitor or track the progress made by a user in a particular topic and suggest cohort groups for user selection, based on, criteria such as but not limited to, the user's expertise in a particular topic. Regular consumption of content related to the particular topic by the user, can lead to the user gaining more knowledge and expertise in the topic. In this case, it is likely that a currently selected cohort group is not an optimal match for the user for that particular topic in terms of expertise, as the user may constantly be rated highly in such a cohort group. In this instance, it is likely that the user will have a more fulfilling experience with the expertise engine 100 if the user is moved to another cohort group which has greater expertise in the particular topic in which the user has improved, as compared to the currently selected cohort group. Accordingly, in an embodiment, the group selection module 2120 can be configured to suggest the other cohort group with greater expertise for user selection. In an embodiment, the group selection module 2120 can automatically move the user into the cohort group with greater expertise based on, for example, the settings associated with the user account. Moving the user to a cohort group with greater expertise can lead to better content recommendations as content from such other users with greater expertise can be forwarded to the user being moved and the user will also have a more exciting learning experience with the expertise engine 100 as the user can be associated with other users having substantially equivalent expertise rather than having lower expertise as would be the case if the user were not moved.

A scoring module 220 also included in the expertise engine 100 generates the user's scores and the scores of a selected cohort group for the topics selected by the topic selection module 2110. As described supra, a plurality of cohort groups can be made available for user selection. In an embodiment the user can choose a single cohort group for comparison of the user's respective score for all topics. In an embodiment, the user can choose different cohort groups to be associated with different topics. The scoring module 220 comprises a score generation module 2210 that accesses the user's previous activity history from user logs 150 and estimates the user's knowledge/expertise regarding particular topics from the user's previous activities. For each user, an initial score is assigned that is indicative of the user's knowledge in each of the topics/entities, such as but not limited to, personalities, locations, shows, movies, areas of study or events. In one embodiment, the initial score is computed by a function that combines the number of articles/content items that the user has visited/consumed over the last X days (X being a natural number), and the intensity score provided by the content processing engine 120 for each entity/concept and content pair. For example, to get the initial score of entity ‘e’ for the user ‘u’, the content items that the user u has consumed over the last X days are obtained and for each content item ‘a’ the content processing engine 120 provides the aboutness intensity W_e_a of the entity e in that particular content item a. The score for the user for topic/entity e is computed as:

SUM_over_a{α_t_a*W_e_a}

where α_t_a is a decay factor which can be computed as a function of time t that has elapsed since the article ‘a’ was consumed by the user. In one embodiment, an exponential function can be used to boost the contribution of more recent contents to the initial score. In one embodiment, an additional weight can be used in the above formula to reflect the degree of “difficulty” or sophistication of the content a for the entity/topic e (e.g., beginner, intermediate, advanced). For example, an article in ACM (Association for Computing Machinery) or IEEE (Institute of Electrical and Electronics Engineers) journals will carry greater weight for difficulty/sophistication than an article in New York Times technology section for concepts related to computer science and engineering. In one embodiment, a machine learning component within the score generation module 2210 can be used to generate the initial scores. In an embodiment, a crowd sourcing mechanism can be employed to generate the above score.

The score generation module 2210 not only generates the initial scores described supra for the user u but it also generates the above scores for the other users in the cohort group selected by the user u for the topic/entity e. In one embodiment, the scores for the other users may be readily available to the score generation module 2210, if, for example, the other users also have the topic/entity e listed as a topic of interest/expertise or if it was pre-calculated for the other users as they form part of other cohort groups. In one embodiment, a score for the other users may have to be determined by the score generation module 2210 while generating the score for the user u if it is not readily available.

The initial scores generated by the score generation module 2210 are provided to the score output module 2220. The score output module 2220 can calculate a relative score or generate a map showing the relative score of the user u regarding the topic/entity e relative to the cohort group selected by the user u for the entity e. By the way of illustration and not limitation, the relative knowledge of a user u about a topic e compared to a cohort group is obtained by generating a histogram of the scores for all the users in the cohort group for the topic e and determining the percentile range in which the score of the user u lies within the histogram. In an embodiment, the user u can select various options for formatting the final report that shows the relative score. For example, the scores of the user u along with the other users in the cohort group can be displayed as data points within the graph with the relative position of the user u highlighted within the diagram.

A recommendation module 230 receives the scores of a user and associated cohort group(s) for each of the topics selected by the topic selection module 2110, determines the topics in which the user has greater and/or lesser competence as compared to the cohort group(s) and recommends content items to the user for improving the user's score. The recommendation module 230 comprises a score analysis module 2310 which receives a user's topics, respective scores of the user for the topics relative to the selected cohort group(s) and determines the level of competence or knowledge of the user regarding each of the received topics. By the way of illustration and not limitation, the score analysis module 2310 can be configured to compare the user's scores to different thresholds in order to determine the user's relative competence in each topic. By the way of illustration and not limitation, a threshold score to determine a user's competence level for a topic can comprise a value obtained by normalizing the scores for all the users for that topic. Based on the comparison with the thresholds, the score analysis module 2310 can determine if the user has elementary, intermediate or expert knowledge in each of the received topics. In an embodiment, the results generated by the score analysis module 2310 can be provided to score output module 2220 in order to add further information to the results. By the way of illustration and not limitation, the score output module 2220 can generate a graphical illustration that depicts the user's relative competence in the various topics based on the input received from the score analysis module 2310.

The scores and evaluations from the score analysis module 2310 are provided to the content providing module 2320 which, in association with the entity store 170, recommends content personalized to the user's score/level of competence for each topic. In one embodiment, the content provided to the user can be tailored to increase the user's score relative to the cohort group. For example, if it is determined that the user is weak in a particular topic, content items associated with the topic which have not been previously consumed by the user but which have been consumed by the other users in the cohort group can be provided to the user. In an embodiment, such content items can have a higher level of sophistication/difficulty than the content normally consumed by the user. In an embodiment, if the user is identified as an expert user relative to the cohort group, content items with higher level of difficulty/sophistication or more specialized content which was not previously consumed by the user can be recommended.

The characterization of users based on their level of knowledge with respect to various topics can provide opportunities for implementing various social networking and monetizing schemes as described herein. In one embodiment, if the user is determined to be an expert user in the topic, the content providing module 2320 can forward items such as questions from other users based on the permissions set by the expert user. In one embodiment, such user characterization can provide monetizing opportunities wherein the advertisement server 160 can target certain advertisements associated with, for example, specialized photographic products to users who are experts or have high scores in photography versus the users who are novices or have intermediate level scores.

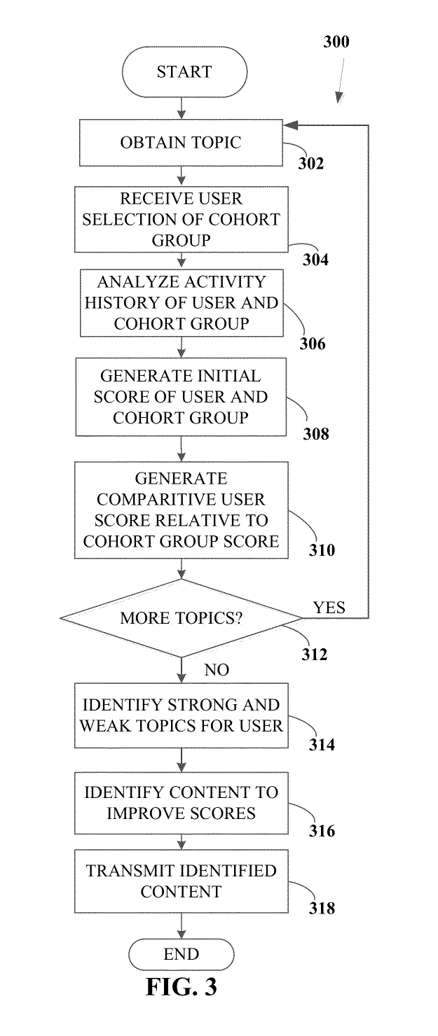

FIG. 3 shows a flowchart 300 illustrating an embodiment of a method of recommending content to the user based in the user's expertise or knowledge in different topics. The method begins at 302 wherein a topic selected from among the various topics associated with the user is obtained. The various topics may be associated with the user automatically based on the user's activity history as retrieved from the user logs 150 or the topics can be supplied by the user or combinations thereof are also contemplated in accordance with an embodiment. In one embodiment, a topic can be selected by the user for estimation of user's initial score and comparative scores. In an embodiment, the topic can be automatically selected for updating the user's scores based on updates in the user's activity history as recorded in the user logs 150. Although the processing for each topic is shown herein as occurring serially, it can be appreciated that this is only by means of illustration and not limitation and that the processing of user scores for all the topics can occur simultaneously in parallel. At 304 the user's selection of a cohort group for the selected topic is received. In an embodiment, the cohort group can be a default cohort group automatically selected based on the user's attributes such that the cohort group comprises other users who have demographic, location, professional or other attributes similar to that of the user. In an embodiment, the cohort group can be selected by the user from the user's social contacts, email contacts, instant messenger contacts or combinations thereof. At 306, the activity history of the user and respective activity histories of each of the other users in the selected cohort group are analyzed and the initial scores of the user and the cohort group for the selected topic are generated as shown at 308. In an embodiment, the initial score of the user for the topic is determined based on one or more of the intensity and the level of difficulty or sophistication associated with user activity for the topic as observed from the user logs 150. Additionally, the initial scores of each of the other users in the cohort groups for the topic is also obtained based on their respective activities as retrieved from the user logs 150. At 310, the user's score for each of the topics is mapped relative to the scores of the cohort group and a comparative or releative score is determined for the user relative to the cohort group score for the selected topic. In an embodiment, a histogram of scores of the user versus the scores of the other users in the cohort group for the topic can be created and the relative range or the comparative score for the user for the selected topic within the cohort group can be provided as an indication of the user's expertise or level of knowledge in the topic. In an embodiment, the same cohort group can be used for comparison purposes for all the topics. In an embodiment, a plurality of cohort groups can be used for comparison purposes with respect to different topics based on the user's topic and cohort group selections described supra. At 312, it is determined if there are more topics for which the user's scores need to be processed as described supra. If yes, the process returns to 302 wherein the next topic is selected. If there are no more topics to be processed, the procedure moves to step 314 wherein the strong and weak topics for the user are identified. In an embodiment, various thresholds can be associated with each of the topics and based on a comparison of one or more of the user's initial score or comparative scores with respective thresholds, the user's proficiency in each of the topics can be determined. In an embodiment, the user can be determined to be a novice with rudimentary knowledge in a topic, or the user may be determined to have intermediate knowledge in the topic or the user can be recognized as an expert in the topic.

In one embodiment, the various topics can be classified as strong and weak topics for the user based, for example, on comparison of the user's score with that of the cohort group scores associated with the topic. By the way of illustration and not limitation, a median score for other users of the associated cohort group can be obtained from the activity histories of the other users and based on comparison of the user's initial score with the median score, the topic can be classified as a strong or a weak topic for the user relative to the cohort group. For example, the expertise engine 100 can preset a score threshold for each cohort group and topic pair whereby if the user's score is equal to or exceeds the threshold, the topic is classified as a strong topic for the user or otherwise classified as a weak topic for the user. In an embodiment, the strong and weak topics for a user can be determined based on a comparison within the user's scores for the various topics regardless of the scores of the cohort group. The methodology for determining the user's strong and weak topics can be based, for example, on the user preferences.

At 316, content to improve the user's score in each of the topics is identified. In an embodiment, the identified content items can comprise those which the user has not previously accessed. In an embodiment, the identified content can have a difficulty/sophistication higher than the content retrieved from the user's previous history as recorded in the user logs 150. In an embodiment, the identified content can comprise text, audio or video items or combinations thereof. In an embodiment, the identified content can also comprise information regarding nearby locations that the user can visit or local events that the user can attend in order to improve the user's knowledge in the topic. Such information can be obtained based on the location information supplied by the user to the expertise engine 100. At 318, the identified content is transmitted to the user. By the way of illustration and not limitation, the identified content can be displayed to the user in a personalized home page or a mobile application associated with the user within the expertise engine 100. In an embodiment, the identified information can also be transmitted to the user via email or other alert systems that the user may have configured for the user's account with the expertise engine 100.

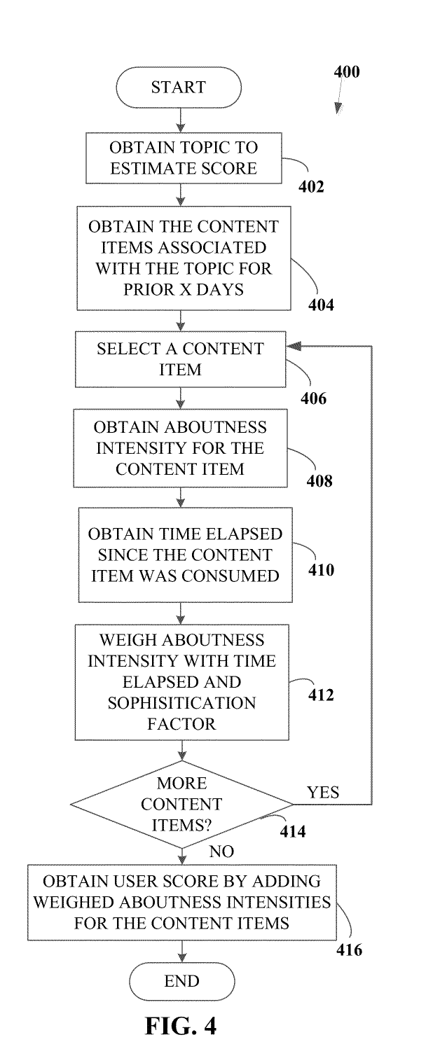

FIG. 4 is a flowchart 400 illustrating an embodiment of a method of determining a user's score for a topic based on the user's activity history. The method begins at 402 wherein a topic is obtained to estimate the user's score indicative of the user's knowledge in the topic. At 404, content items associated with the topic that were consumed by the user over the previous ‘X’ (X being a natural number) days are obtained, for example, from the user logs 150. The content items can be articles or multimedia items. At 406, a content item is selected and its aboutness intensity is obtained as shown at 408. In an embodiment, the aboutness intensity can indicate how closely the content item is associated with the topic. For example, the aboutness intensity can indicate if the content item comprises only a fleeting reference to the topic or if the content item has a more thorough description or analysis associated with the topic. At 410, the time that has elapsed since the content item was consumed by the user is obtained. At 412, the aboutness intensity is weighed by a decay factor that can be computed as a function of the time that elapsed since the content item was consumed by the user so that recently consumed content items are weighed higher that older content items in the user's activity history. For example, an exponential function can be used to boost the contribution of more recent contents to the user's score. Moreover, an additional weight can be used with the aboutness intensity to reflect the degree of difficulty or sophistication associated with content item. At 414 it is determined if more content items are remaining to be processed for the selected topic. If yes, the process returns to step 406 wherein the next content item is obtained. If no more content items remain to be processed, the method proceeds to step 416 wherein the weighed aboutness intensities for all the articles are summed to obtain the user's initial score that indicates the user's level of knowledge in the topic. Again, it may be appreciated that the flowchart 400 shows the content items as being processed serially only by the way of illustration and not limitation and that all the content items can be processed simultaneously via parallel processing in accordance with an embodiment. In an embodiment, an initial score as described herein is calculated for each user within a cohort group for comparison purposes.

In an embodiment, the methods described herein can be executed for updating the user's score based on updates in the user's activity as recorded by the user logs 150. In an embodiment, the user activity as recorded in the user logs 150 can be updated if the user consumes the additional content forwarded to improve the user's score for a particular topic.

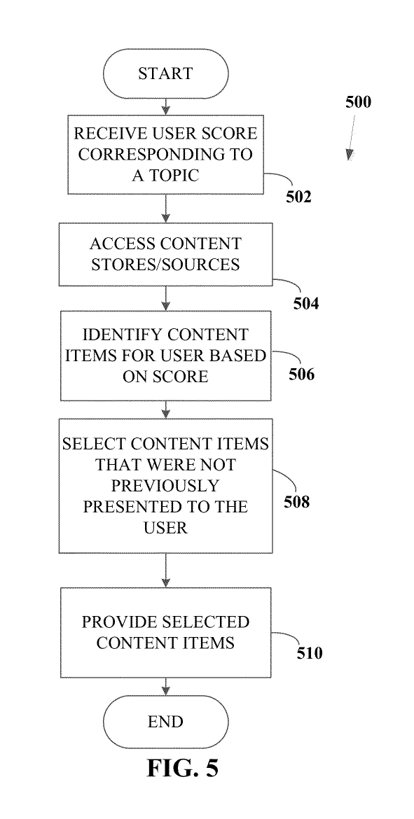

FIG. 5 is a flowchart 500 illustrating an embodiment of a method of selecting topic-specific content for a user based on the user's score indicative of the user's knowledge in the topic. The method begins at 502 wherein an initial score of the user indicative of the user's knowledge in the topic estimated in accordance with embodiments described herein is obtained. At 504, various content stores and/or sources can be accessed. In an embodiment, the content items can be previously obtained, processed and stored on computer readable storage media so that the expertise engine 100 can access the content items. In an embodiment, the content items can be obtained directly from the content sources which provide the requisite metadata, such as but not limited to, titles, tags, keywords or other descriptive data that facilitate identifying the topics of relevance for the content items. The content items are retrieved from the content stores/sources based on the user's score as shown at 506. A user's score as detailed supra, is indicative of whether the user is a novice, has intermediate knowledge of or if the user is an expert in the topic. Accordingly, content items characterized by a suitable difficulty or sophistication factor described herein can be retrieved at 506. Thus, content with low sophistication is selected for a novice whereas increasingly sophisticated content can be selected for intermediate and expert users for improving their scores. In one embodiment, this can provide monetization opportunities as expert users to whom specialized content can be marketed are identified through this process. At 508, content items that were not previously consumed by the user are selected from the retrieved content items and provided to the user as shown at 510. Thus, a user's level of knowledge in a particular topic can be factored into the content recommended to the user.

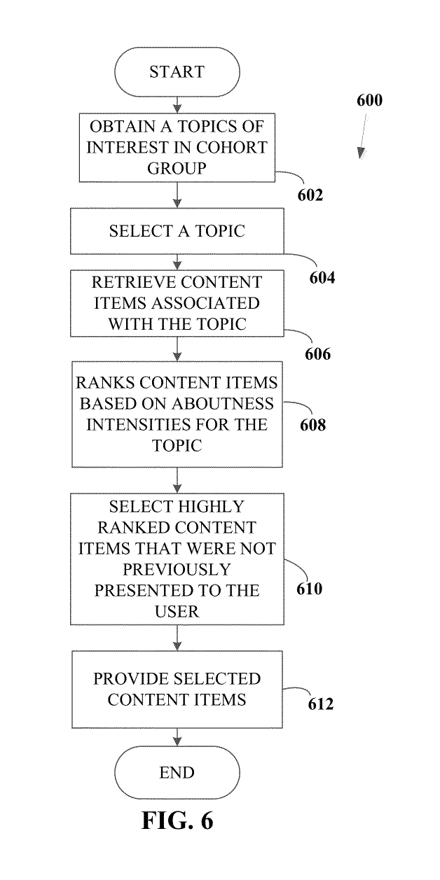

FIG. 6 is a flowchart 600 illustrating an embodiment of a method of selecting topic-specific content for a user based on interests within the user's cohort group. The method begins at 602 wherein a topics of interest for the user's cohort group is obtained. As described herein, a plurality of cohort groups can be associated with a user. In one embodiment, the topics of interest are retrieved for a cohort group from the plurality which is default cohort group or a dominant cohort group with which the user interacts most frequently. In one embodiment, if such a cohort group cannot be identified, then the topics of interest for a default cohort group comprising users whose attributes most closely match the attributes of the user are retrieved. At 604 a topic is selected and the content items associated with the selected topic are retrieved at 606. At 608, the retrieved content items are ranked, for example, in a descending order of their respective aboutness intensities for the selected topic so that those content items which are most closely associated with the topic are ranked higher. In an embodiment, the aboutness intensity indicates the extent to which or how closely the content item is associated with the topic or the strength of the association between the content item and the topic. In an embodiment, it can be obtained as predefined metadata along with the content item from the entity store 170. The ranked content items can be processed, for example, in a descending order of their ranks to identify those content items which were not previously consumed by the user. At 610, the highest ranked content items which were not forwarded previously to the user are selected and provided to the user at 612.

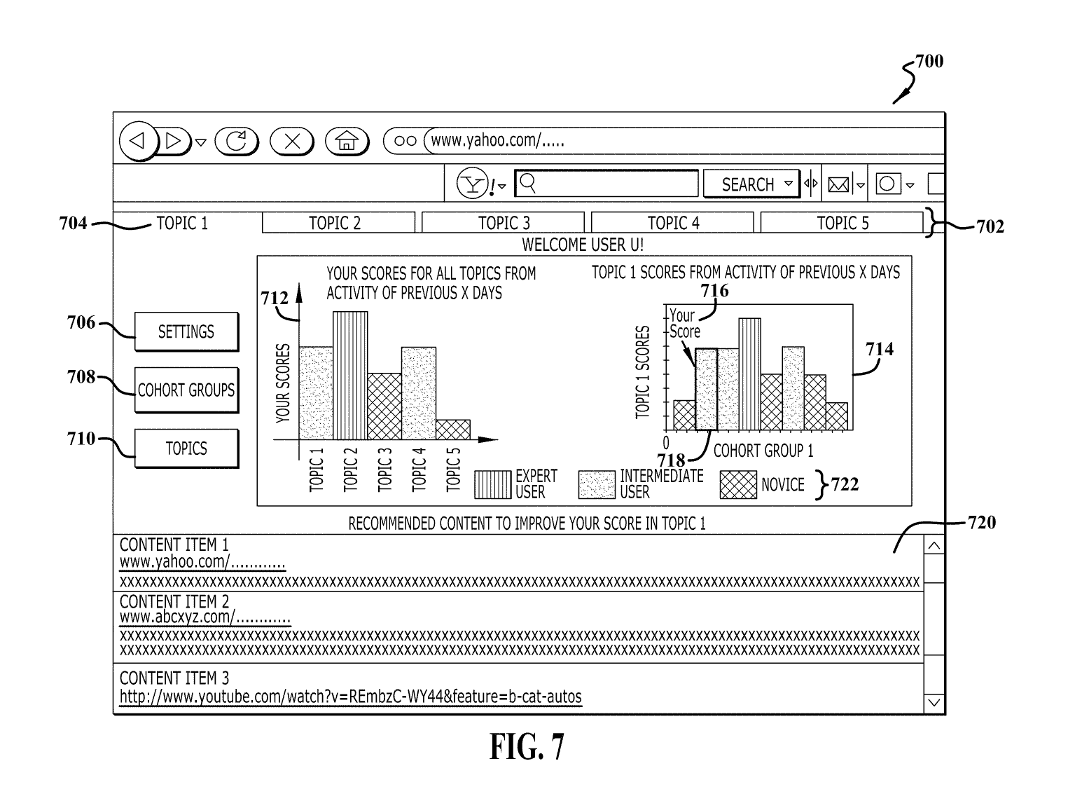

FIG. 7 is an illustration showing a schematic diagram of a user interface 700 wherein the scores for various topics and associated recommended content are provided to the user in accordance with an embodiment of the present disclosure. In accordance with an embodiment, user interface 700 is a webpage generated by the expertise module 100 for a particular user ‘u’. It may be appreciated that user interface 700 is depicted as a webpage only by the way of illustration and that other user interfaces can be generated by the expertise engine 100 for other stationary or mobile devices in accordance with other embodiments. As seen from the user interface 700, user u has five topics, topic 1, topic 2, topic 3, topic 4 and topic 5, associated therewith and the information regarding each of the five topics is displayed in a respective one of the tabs 702. It may be appreciated that the details of the user interface are only shown by the way of illustration and not limitation and that other user interface elements can be used to display the user information from the expertise engine 100. For example, drop-down boxes (not shown) can be provided to facilitate selections of topics and associated cohort groups. The tab 704 associated with topic 1 is selected and accordingly information of the user u with respect to topic 1 is displayed. Additionally, buttons 706, 708 and 710 are provided to facilitate executing various tasks associated with managing the user/topic information within the expertise engine 100. By the way of illustration and not limitation, these can include the ‘settings’ button 706, cohort groups button 708 and the topics button 710. In an embodiment, the settings button 706 can facilitate a user to input, modify or delete information associated with the user's account, such as user's attributes, within the expertise engine 100. In an embodiment, the cohort groups button 708 facilitates user management of the cohort groups associated with the user's account, such as, adding or removing cohort groups or particular members of the user-provided cohort groups or altering the association of cohort groups with various topics. As discussed supra, different cohort groups can be associated with different topics and such associations can be changed by the user independently or based on suggestions by the expertise engine 100. In an embodiment, a change of cohort group to another cohort group determined to have greater expertise than a currently selected cohort group can be suggested to the user by the expertise engine 100 if the user is designated as an expert within the selected cohort group for a time period that equals or exceeds a threshold time period preset within the expertise engine 100.

In an embodiment, user management of topics associated with the user's account can be facilitated via a user interface (not shown) displayed upon activation of the topics button 710. In an embodiment, the topics for the user are automatically selected by the expertise engine 100 from the user's activity history as recorded in the user logs 150. Activation of the topics button 710 can facilitate various functions such as showing the strong and weak topics of the user u, relative to the respective cohort group(s) or relative to other topics, receiving additional user input, for example, for limiting the number of topics to be associated with the user account, for adding particular topics or for deleting topics which are no longer of interest to the user.

In an embodiment, the user interface 700 displays some information unique to each of the tabs 702 while some of the information can be commonly displayed across all the tabs 702. By the way of illustration and not limitation, the buttons 706, 708, 710 and the plot 712 showing the user's score for all the topics can be commonly displayed across the topic tabs 702. In an embodiment, the plot 712 shows the user's score as obtained from the user's activity log for each of the topics over the previous ‘X’ days. In an embodiment, the user's score can be updated periodically or it can be updated when the user logs into the expertise engine 100. It may be appreciated that the user's score in various topics is displayed as a histogram only by the way of illustration and not limitation and that other appropriate graphical forms such as, pie diagrams, line graphs or other pictorial forms can be used to display to user's scores. The various graphical forms can be used based on, for example, the user's preferences. In one embodiment the expertise engine 100 can set common scoring levels for all the topics in order to classify the user as a novice, intermediate user or an expert. In one embodiment, the scores for classifying users can be unique for each of the topics. By the way of illustration and not limitation, the legend 722 can indicate the different proficiency levels for the users in various topics within the expertise engine 100. Accordingly, the plot 712 shows that the user u is an expert in topic 2, has intermediate level knowledge in topics 1 and 4 and is a novice in topics 3 and 5. In an embodiment, a type of display can be associated with each of the topic scores within the plot 712 in a manner that indicates the strong and weak topics of the user u relative to respective cohort groups. By the way of illustration and not limitation, the pattern within the bars representing the scores can be highlighted for topics in which the user is proficient relative to an associated cohort group and may be grayed out for topics in which the user is weak as compared to the associated cohort group. As discussed supra, the information regarding strong and weak topics can be provided via the topics button 710. Additionally, the display under each of the topic tabs 702 can vary based on the user's status with respect to the topic. For example, the display for topic 2 in which the user u is an expert, can vary as compared to the displays under the other tabs. In an embodiment, the display for the topic 2 can include a separate Question/Answer section showing information such as, but not limited to, questions from other users forwarded to the user u for response, the responses provided by the user u for different questions, feedback from other users for the responses provided by the user u.

The user interface 700 also includes a plot 714 that shows the scores and classification for all the users of cohort group 1 which is associated with topic 1. Again, it may be appreciated that the information is displayed as a histogram only by the way of illustration and not limitation and that other appropriate graphical forms such as, pie diagrams, line graphs or other pictorial forms can be used to display the information in different formats. In one embodiment, the legend 722 provides information regarding various proficiency levels. Based on the legend 722, the proficiency of each of the users of cohort group 1 for the topic 1 relative to each other can be determined from the plot 714. In an embodiment, one or more of a label 716 or a highlight 718 can be used to show or emphasize the score of user u within the cohort group score. In an embodiment, the graph 714 shows the status/classification of each of the users in the cohort group 1 with respect to the topic 1. Based on the display it can be determined that user u has intermediate level knowledge in topic 1 and that there is one expert in the cohort group 1 in topic 1. In an embodiment, the plot 714 can display identities of other users in the cohort group 1, based on their respective permissions.

The content recommendations section 720, also included in the user interface 700, shows three of the content items that are recommended to the user based on the user's scores and the user's activity history. As described supra, content that is highly rated for the topic 1 or entities associated therewith is filtered based on one or more of the user's knowledge level or the user's activity history and forwarded to the user u. The content forwarded to the user can comprise text, audio, video items or combinations thereof. In an embodiment, the content recommendations section 720 also includes location or event information that a user can visit in order to improve his/her score or a Q/A section with answers provided by experts in topic 1 to the questions posed by the user u or other users.

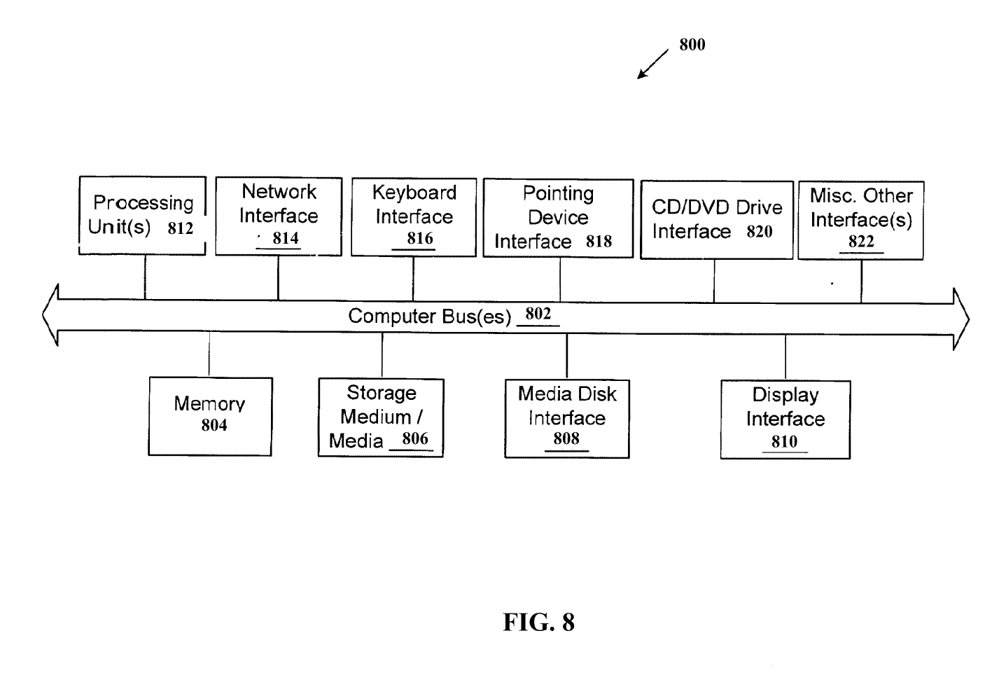

As shown in the example of FIG. 8, internal architecture of a computing device 800 includes one or more processing units (also referred to herein as CPUs) 812, which interface with at least one computer bus 802. Also interfacing with computer bus 802 are persistent storage medium/media 806, network interface 814, memory 804, e.g., random access memory (RAM), run-time transient memory, read only memory (ROM), etc., media disk drive interface 808, an interface 820 for a drive that can read and/or write to media including removable media such as floppy, CD-ROM, DVD, etc., media, display interface 810 as interface for a monitor or other display device, keyboard interface 816 as interface for a keyboard, pointing device interface 818 as an interface for a mouse or other pointing device, and miscellaneous other interfaces 822 not shown individually, such as parallel and serial port interfaces, a universal serial bus (USB) interface, and the like.

Memory 804 interfaces with computer bus 802 so as to provide information stored in memory 804 to CPU 812 during execution of software programs such as an operating system, application programs, device drivers, and software modules that comprise program code, and/or computer-executable process steps, incorporating functionality described herein, e.g., one or more of process flows described herein. CPU 812 first loads computer-executable process steps from storage, e.g., memory 804, storage medium/media 806, removable media drive, and/or other storage device. CPU 812 can then execute the stored process steps in order to execute the loaded computer-executable process steps. Stored data, e.g., data stored by a storage device, can be accessed by CPU 812 during the execution of computer-executable process steps.

Persistent storage medium/media 806 is a computer readable storage medium(s) that can be used to store software and data, e.g., an operating system and one or more application programs. Persistent storage medium/media 806 can also be used to store device drivers, such as one or more of a digital camera driver, monitor driver, printer driver, scanner driver, or other device drivers, web pages, content files, playlists and other files. Persistent storage medium/media 806 can further include program modules and data files used to implement one or more embodiments of the present disclosure.

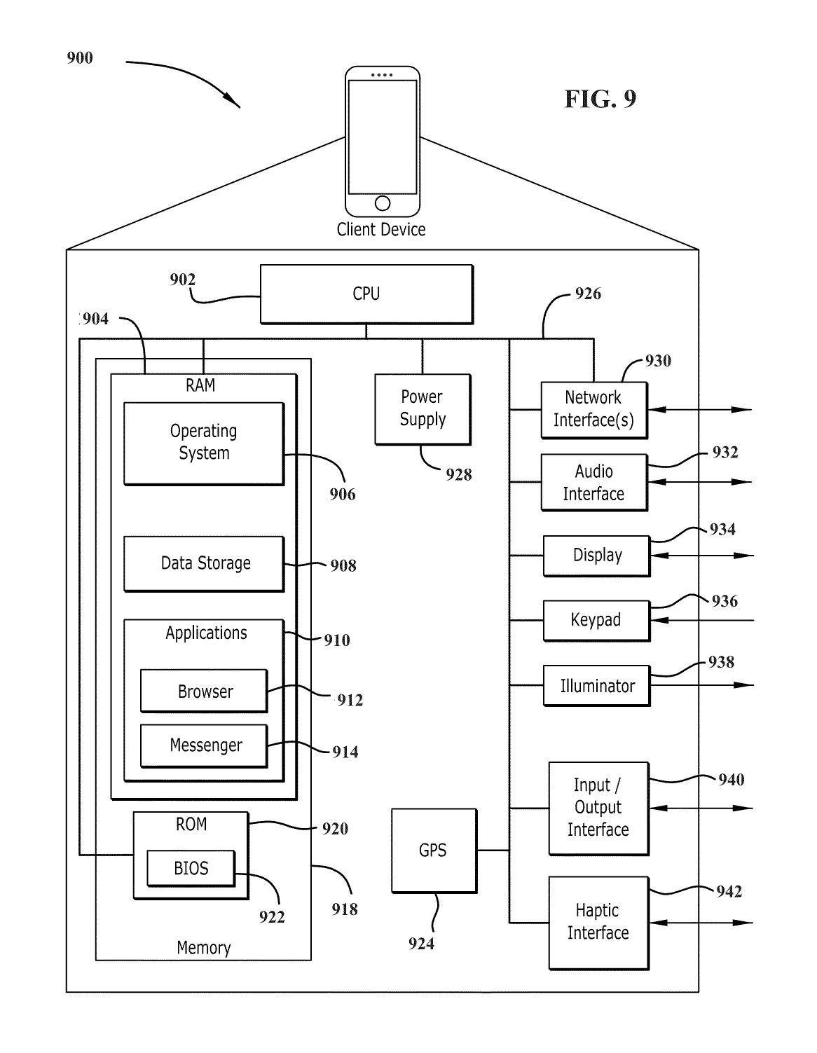

FIG. 9 is a schematic diagram illustrating a client device implementation of a computing device in accordance with embodiments of the present disclosure. A client device 900 may include a computing device capable of sending or receiving signals, such as via a wired or a wireless network, and capable of running application software or “apps”. A client device may, for example, include a desktop computer or a portable device, such as a cellular telephone, a smart phone, a display pager, a radio frequency (RF) device, an infrared (IR) device, a Personal Digital Assistant (PDA), a handheld computer, a tablet computer, a laptop computer, a set top box, a wearable computer, an integrated device combining various features, such as features of the forgoing devices, or the like.

A client device may vary in terms of capabilities or features. The client device can include standard components such as a CPU 902, power supply 928, a memory 918, ROM 920, BIOS 922, network interface(s) 930, audio interface 932, display 934, keypad 936, illuminator 938, I/O interface 940 interconnected via circuitry 926. Claimed subject matter is intended to cover a wide range of potential variations. For example, the keypad 936 of a cell phone may include a numeric keypad or a display 934 of limited functionality, such as a monochrome liquid crystal display (LCD) for displaying text. In contrast, however, as another example, a web-enabled client device 900 may include one or more physical or virtual keyboards 936, mass storage, one or more accelerometers, one or more gyroscopes, global positioning system (GPS) 924 or other location identifying type capability, Haptic interface 942, or a display with a high degree of functionality, such as a touch-sensitive color 2D or 3D display, for example. The memory 918 can include Random Access Memory 904 including an area for data storage 908.

A client device may include or may execute a variety of operating systems 906, including a personal computer operating system, such as a Windows, iOS or Linux, or a mobile operating system, such as iOS, Android, or Windows Mobile, or the like. A client device 900 may include or may execute a variety of possible applications 910, such as a client software application 914 enabling communication with other devices, such as communicating one or more messages such as via email, short message service (SMS), or multimedia message service (MMS), including via a network, such as a social network, including, for example, Facebook, Linkedln, Twitter, Flickr, or Google+, to provide only a few possible examples. A client device 900 may also include or execute an application to communicate content, such as, for example, textual content, multimedia content, or the like. A client device 900 may also include or execute an application 912 to perform a variety of possible tasks, such as browsing, searching, playing various forms of content, including locally stored or streamed video, or games (such as fantasy sports leagues). The foregoing is provided to illustrate that claimed subject matter is intended to include a wide range of possible features or capabilities.

For the purposes of this disclosure a computer readable medium stores computer data, which data can include computer program code that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium. Modules may be integral to one or more servers, or be loaded and executed by one or more servers. One or more modules may be grouped into an engine or an application.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client or server or both. In this regard, any number of the features of the different embodiments described herein may be combined into single or multiple embodiments, and alternate embodiments having fewer than, or more than, all of the features described herein are possible. Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

While the system and method have been described in terms of one or more embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

What is claimed is:

1. A method comprising:
analyzing, by a processor, activity history of a first user;
obtaining, by the processor, a plurality of topics of interest from the activity history;
determining, by the processor, an initial score indicative of knowledge of the first user about at least one of the plurality of topics from the activity history;
generating, by the processor from the initial score, a relative score indicative of the knowledge of the first user about the at least one topic relative to at least one cohort group comprising other users;
identifying, by the processor, additional content for increasing the initial score of the first user; and
transmitting, by the processor, the additional content to the first user.

2. The method of claim 1, further comprising:
determining, by the processor, initial scores for each of the other users from respective activity histories; and
comparing, by the processor, the initial score of the first user with the initial scores of the other users to generate the relative score.

3. The method of claim 1, further comprising:
identifying, by the processor, the other users having attributes similar to the first user;
generating, by the processor, the cohort group comprising the other users with the similar attributes.

4. The method of claim 1, further comprising:
obtaining, by the processor, content items associated with the at least one topic;
determining, by the processor, an aboutness intensity for each of the obtained content items, the aboutness intensity is indicative of a strength of association between each of the obtained content items and the at least one topic;
ranking, by the processor, the obtained content items based on respective aboutness intensities;
selecting, by the processor, highly ranked content items previously not accessed by the first user as the additional content to be transmitted to the user.

5. The method of claim 1, further comprising:
classifying, by the processor, the first user as one of a novice, an intermediate user or an expert based on the initial score.

6. The method of claim 5, further comprising:
receiving, by the processor, a question associated with the at least one topic from a second user.

7. The method of claim 6, further comprising:
forwarding, by the processor, the question to the first user, if the first user is classified as an expert on the at least one topic.

8. The method of claim 7, wherein the question is forwarded based on permissions set by the first user.

9. The method of claim 5, further comprising:
serving, by the processor, an advertisement to the first user based on the classification.

10. The method of claim 1, wherein the at least one topic is selected by the first user from the plurality of topics.

11. The method of claim 1, further comprising:
selecting, by the processor, the at least one topic from the plurality of topics.

12. The method of claim 1, further comprising:
suggesting, by the processor, a plurality of possible cohort groups for selection by the first user;
receiving, by the processor, from the first user, selection of a respective cohort group from the plurality of possible cohort groups for each of the plurality of topics.

13. The method of claim 12, further comprising:
determining, by the processor, respective initial scores for the first user for each of the plurality of topics.

14. The method of claim 13, further comprising:
generating, by the processor, respective relative scores indicative of knowledge of the first user about each of the plurality of topics relative to a respective cohort group; and
identifying, by the processor, strong and weak topics for the first user from the plurality of topics based on the relative scores.

15. The method of claim 13, further comprising:
monitoring, by the processor, an improvement in the relative score of the first user such that at least one of the plurality of possible cohort groups comprises other users with greater expertise in the at least one topic as compared to the at least one cohort group currently selected for the at least one topic.

16. The method of claim 1, the step of determining an initial score further comprising:
obtaining, by the processor, content items associated with the at least one topic for prior X days from the activity history, X being a natural number;
receiving, by the processor, aboutness intensities for each of the content items for the at least one topic;
weighing, by the processor, the aboutness intensities for each of the content items with respective time decay factor and sophistication factor;
determining, by the processor, the initial score for the user based on the weighed aboutness intensities for the content items.

17. A computing device comprising:
a processor;
a storage medium for tangibly storing thereon program logic for execution by the processor, the program logic comprising:
analyzing logic, executed by the processor, for analyzing activity history of a first user;
obtaining logic, executed by the processor, for obtaining a plurality of topics of interest from the activity history;
determining logic, executed by the processor, for determining an initial score indicative of knowledge of the first user about at least one of the plurality of topics from the activity history;
generating logic, executed by the processor, for generating a relative score indicative of the knowledge of the first user about the at least one topic relative to at least one cohort group comprising other users;
content identifying logic, executed by the processor, for identifying additional content for increasing the initial score of the first user; and
transmitting logic, by the processor, for transmitting the additional content to the first user.

18. The device of claim 17, the determining logic further comprising:
logic for determining initial scores for each of the other users from respective activity histories; and
logic for comparing, the initial score of the first user with the initial scores of the other users to generate the relative score

19. The device of claim 17, the determining logic further comprising:
logic for obtaining content items associated with the at least one topic for prior X days from the activity history, X being a natural number;
logic for receiving aboutness intensities for each of the content items for the at least one topic;
logic for weighing the aboutness intensities for each of the content items with respective time decay factor and sophistication factor; and
logic for determining the initial score for the user based on the weighed aboutness intensities for the content items.

20. The device of claim 17, further comprising:
user identifying logic, executed by the processor, for identifying the other users having attributes similar to the user;
group generating logic, executed by the processor, for generating the cohort group comprising the other users with the similar attributes.

21. The device of claim 17, the content identifying logic further comprising:
logic for obtaining content items associated with the at least one topic;
logic for determining an aboutness intensity for each of the obtained content items, the aboutness intensity indicates a strength of association between each content item and the at least one topic;
logic for ranking the content items based on respective aboutness intensities;
logic for selecting highly ranked content items previously not accessed by the first user as the additional content to be transmitted to the user.

22. The device of claim 17, further comprising:
classifying logic, executed by the processor, for classifying the first user as one of a novice, an intermediate user or an expert based on the initial score.

23. A computer readable storage medium, having stored thereon, instructions which when executed by a processor, cause the processor to:
analyze activity history of a first user;
obtaining a plurality of topics;
determine an initial score indicative of knowledge of the first user about at least one of the plurality of topics from the activity history;
generate a relative score from the initial score, the relative score is indicative of the knowledge of the first user about the at least one topic relative to at least one cohort group comprising other users;
identify additional content for increasing the initial score of the first user; and
transmit the additional content to the first user.

24. The medium of claim 23, further comprising instructions to:
determine initial scores for each of the other users from respective activity histories; and
compare the initial score of the first user with the initial scores of the other users to generate the relative score.

25. The medium of claim 23, further comprising instructions to:
obtain content items associated with the at least one topic;
determine an aboutness intensity for each of the obtained content items, the aboutness intensity is indicative of a strength of association between each content item and the at least one topic;
rank the content items based on respective aboutness intensities;
select highly ranked content items previously not accessed by the first user as the additional content to be transmitted to the user.
